(19) United States
(12) Patent Application Publication
(10) Pub. No.: US 2021/0010176 A1
(43) Pub. Date: Jan. 14, 2021

(54) METHOD FOR PRODUCING SEWING DATA FILE USING EMBEDDED COMPUTER

(71) Applicant: Mobase Sunstar Co., Ltd., Incheon (KR)

(72) Inventor: Byeong Jun Son, Incheon (KR)

(21) Appl. No.: 17/030,407

(22) Filed: Sep. 24, 2020

Related U.S. Application Data
(62) Division of application No. 16/177,814, filed on Nov. 1, 2018.

(30) Foreign Application Priority Data
Nov. 9, 2017 (KR) 10-2017-0149023
Jul. 13, 2018 (KR) 10-2018-0081745

(51) Int. Cl. D05B 19/08; D05B 19/10; G06F 3/0488; G06F 3/0484; D05B 19/12

(52) U.S. Cl. CPC D05B 19/085; D05B 19/105; D05B 19/12; G06F 3/04847; G06F 3/04883

(57) ABSTRACT

Disclosed is a method for producing a sewing data file using an embedded computer. A method for producing a sewing data file of a sewing machine allows the embedded computer to perform the following processes: receiving a color of a thread mounted on the sewing machine through the touch input device and the data input device; receiving an image data through the network device; extracting a color component from the image data by referring to a color of a thread mounted on the sewing machine using the sewing data conversion program; and calculating a ratio occupied by a color of a minimum unit pixel for each separated color as an area occupied by a thread using the sewing data conversion program and converting the calculated ratio into a sewing data in a linear shape and a zigzag shape.

### CROSS-REFERENCE TO RELATED APPLICATIONS

This patent application is a divisional application of U.S. patent application Ser. No. 16/177,814, filed on Nov. 1, 2018, which claims priority under 35 u.s.c. § 119 to Korean patent application Nos. 10-2017-0149023, filed on Nov. 9, 2017, and 10-2018-0081745, filed on Jul. 13, 2018, in the korean intellectual property office, the disclosures of which are incorporated by reference herein in their entireties.

### TECHNICAL FIELD

The present invention relates to a method for obtaining results similar to image data or handwriting by performing a sewing operation on sewing materials, such as cloth or leather, using a sewing machine in which threads of various colors can be mounted. More particularly, the present invention relates to a method for producing a sewing data file capable of conveniently converting image data or handwriting into a sewing data form by using a sewing machine having an embedded computer.

### DISCUSSION OF RELATED ART

A sewing machine is automatically operated according to sewing data input to a sewing data file.

The sewing data are predefined digital data form which represents functions, such as a relative distance value on which X and Y axes are to be moved per rotation of a Z axis in a sewing machine, a change signal of a needle moving up and down in association with the Z axis, and a fall prevention of the Z axis.

The sewing machine automatically drives motors of X, Y and Z axes according to the sewing data input to the sewing data file.

That is, the end result is obtained by performing the operation start, the motor operation degree of the X, Y, Z axes, the change in the needle operated in association with the Z axis, and the end of the operation according to the contents recorded in the sewing data.

In other words, the sewing machine performs a sewing operation by automatically changing a stitch start position, a stitch shape (linear shape, zigzag shape, intersecting progress shape, etc.), a stitch length, a width, a direction, a color of a thread and an operation end position according to contents recorded in the sewing data file.

The typical method for producing a sewing data file is as follows.

Conventionally, a sewing data file is produced outside a sewing machine and input to the sewing machine is used.

The sewing data file is input from external devices (USB memory stick, separate smart phone, separate tablet PC, etc.) by using a USB device, an Ethernet device, and a Bluetooth device of the embedded computer installed in the sewing machine.

The conventional method for producing a sewing data file will be described with reference to FIG. 5A.

After image data or the like size-adjusted to a horizontal and vertical size operable by the sewing machine are input to an independent computer in which a dedicated sewing data conversion program is installed, a dedicated sewing data conversion program is operated.

The conventional method for producing a sewing data file sets a color of a thread mounted on the sewing machine according to a color of a photograph, checks the input original file with the naked eye or designates a range of the original file, and converts the original file into the sewing data using the dedicated sewing data conversion program for each part.

At this time, the dedicated sewing data conversion program calculates and sets the operation degree of the motor of X, Y, Z according to a user's choice, the change in the needle moving up and down in association with the Z axis, the position of the operation type, or the like, and produces them in the digital data form. After that, the sewing data file produced is input to the sewing machine to perform the sewing operation.

The conventional methods for producing a sewing data file are produced manually or produced regardless of characteristics of a sewing machine that actually performs sewing.

Accordingly, a need exists for a method for automatically producing a sewing data file in a sewing machine having an embedded computer.

### RELATED ART DOCUMENT

### Patent Document

Korean Patent Laid-Open Publication No. 2003-0059946 (Jul. 12, 2003)

Korean Patent Laid-Open Publication No. 2002-0074136 (Sep. 28, 2002)

### SUMMARY

An object of the present invention is to provide a method for producing a sewing data file for image data using an embedded computer in a sewing machine having an embedded computer.

Another object of the present invention is to provide a method for producing a sewing data file for a handwriting using an embedded computer in a sewing machine having an embedded computer.

According to an aspect of the present invention, there is provided a method for producing a sewing data file of a sewing machine including an embedded computer including a touch screen, a sewing data conversion program, a touch input device, a data input device, and a network device, wherein the method produces a sewing data used in the sewing machine by allowing the embedded computer to perform the following processes: receiving a color of a thread mounted on the sewing machine through the touch input device and the data input device; receiving an image data through the network device; extracting a color component from the image data by referring to a color of a thread mounted on the sewing machine using the sewing data conversion program; and calculating a ratio occupied by a color of a minimum unit pixel for each separated color as an area occupied by a thread using the sewing data conversion program and converting the calculated ratio into a sewing data in a linear shape and a zigzag shape.

The embedded computer further performs receiving a size of a sewing frame through the touch input device and the data input device, and adjusting a size of the image data to the size of the handwriting using the sewing data conversion program.

The embedded computer further performs setting a thread color change order, and referring to the set thread color change order to produce the sewing data.

According to another aspect of the present invention, there is provided a method for producing a sewing data file of a sewing machine including an embedded computer including a sewing data conversion program, a touch input device, a data input device, and a network device, wherein the method produces a sewing data used in the sewing machine by allowing the embedded computer to perform the following processes: receiving a color of a thread mounted on the sewing machine through the touch input device and the data input device; selecting a color to be used, a stitch shape, a thickness and the like through the touch input device and then receiving handwriting; determining a stitch trajectory, the stitch shape, a width, and a color of a thread by allowing the sewing data conversion program to analyze handwriting: and producing a sewing data file by using the stitch trajectory, the stitch shape, the width, and the color of the thread determined for every stitch trajectory.

The embedded computer further performs: receiving a size of a sewing frame through the touch input device and the data input device, and adjusting a size of the image data to the size of the handwriting using the sewing data conversion program.

The embedded computer further perform setting a thread color change order, and referring to the set thread color change order to produce the sewing data.

The sewing machine according to the present invention produces the sewing data file using the image data or the handwriting input using the embedded computer.

As a result, according to the method for producing a sewing data file using the embedded computer according to the present invention, the follow effects or the like can be obtained:

First, the independent computer for producing the sewing data is unnecessary.

Second, the independent sewing data conversion program is unnecessary.

Third, the knowledge and personnel of the sewing data conversion are unnecessary.

Fourth, it is possible to produce the sewing data file using free handwriting.

Fifth, it is possible to automatically adjust the size which has been performed manually, according to the sewing frame size.

Sixth, it is possible to match the color of the thread for the stitch with the color of the thread mounted on the sewing machine.

### BRIEF DESCRIPTION OF THE DRAWINGS

FIG. 1 is a diagram showing an appearance of a sewing machine having an embedded computer.

FIG. 2 is a diagram showing a configuration of the embedded computer embedded the sewing machine shown in FIG. 1.

FIGS. 3A to 3C are diagrams showing an example of image data.

FIG. 4 is a diagram showing an example of handwriting.

FIGS. 5A and 5B are comparison diagrams of a method for producing a sewing data according to the present invention with the related art.

FIG. 6 is a diagram schematically showing a method for automatically converting image data according to a first embodiment of the method for producing a sewing data file of the present invention.

FIG. 7 is a diagram showing an example of various frames used in the sewing machine.

FIGS. 8A and 8B are diagrams showing an example of threads of various colors used in the sewing machine.

FIG. 9 is a flowchart showing a first embodiment of the method for producing a sewing data file according to the present invention.

FIG. 10 is a diagram showing a frame setting menu.

FIG. 11 is a diagram showing a thread color information setting menu.

FIG. 12 is a diagram showing an example of image data displayed on a touch screen.

FIG. 13 is a diagram showing a thread color change order setting menu.

FIG. 14 is a diagram showing sewing materials produced.

FIG. 15 is a diagram schematically showing a method for automatically converting handwriting according to a second embodiment of the method for producing a sewing data file according to the present invention.

FIG. 16 is a flowchart showing the second embodiment of the method for producing a sewing data file according to the present invention.

FIG. 17 is a diagram showing a handwriting input menu.

FIG. 18 is a diagram showing an example of handwriting displayed on the touch screen.

FIG. 19 is a diagram showing sewing materials produced.

### DETAILED DESCRIPTION

Hereinafter, the present invention will be described in detail with reference to the accompanying drawings.

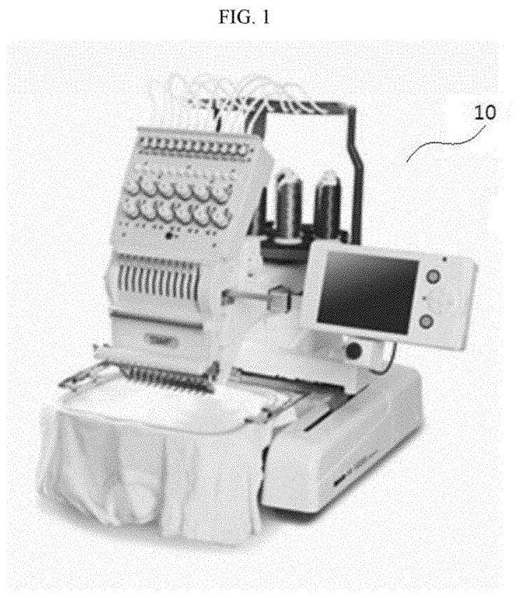

FIG. 1 shows an appearance of a sewing machine having an embedded computer.

The sewing machine 10 includes an XYZ axis driving device driven by a motor, a control device for driving the same, and 1 to 15 needles and a needle bar operated up and down in association with a rotation of an X axis, and an embedded computer for computing, storing, and processing sewing data according to a user operation.

A sewing operation means stitching which uses 1 to 15 needles connected to a Z-axis driving device to move up and down and threads mounted on the needles to represent patterns, which are defined in sewing data in linear and zigzag shapes, on sewing materials, such as cloth and leather, fixed on a frame connected to X and Y axes and moving two-dimensionally.

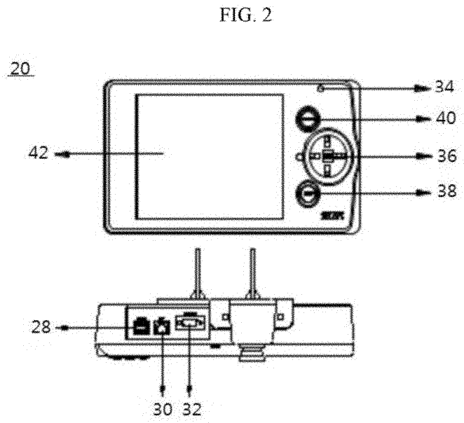

FIG. 2 shows a configuration of the embedded computer embedded the sewing machine shown in FIG. 1.

An embedded computer 20 has a central processing unit (not shown), a random access memory (volatile memory, not shown), and a storage device (not shown).

In addition, the embedded computer 20 includes some or all of a universal serial bus (USB) device 28, an Ethernet device 30, a printer port 32, a Bluetooth device 34, a touch screen 42, a mouse pad 36, operation buttons 38 and 40, and the like, and has a sewing data conversion program installed therein.

The storage device (not shown) is a device for storing and holding sewing data, status information, setting information, and a set value.

The USB device 28 is used to input/output a sewing data file, input a touch screen 42, input a mouse (not shown), input a keyboard (not shown), input a keypad (not shown), or the like.

The Ethernet device 30 uses a LAN cable and a wireless LAN to transmit the input/output of the sewing data and the status information on the sewing machine to the outside.

The Bluetooth device 34 serves as the Ethernet device 30 at a short distance.

The sewing data conversion program includes a thread selection function for selecting a thread shape, a position input function for specifying a stitch trajectory, a stitch shape selection function for selecting stitch shape (linear shape, zigzag shape, intersecting progress shape, etc.), a frame selection function, a sewing data conversion function, or the like.

In addition to these, like a graphic program, the sewing data conversion program performs a file input/output function, a size adjustment function, and the like.

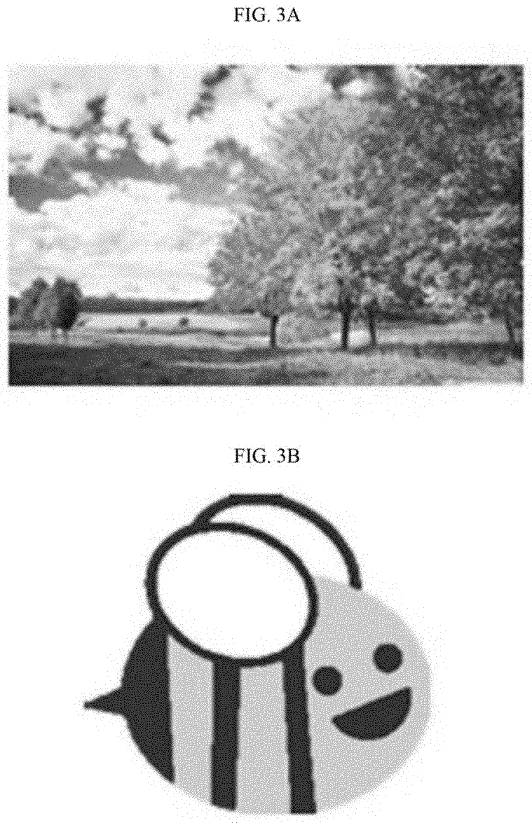

FIGS. 3A and 3C show an example of image data.

The image data are converted into digital, and is collectively referred to as photographs, images, and designs that can be stored and moved.

The image data are input to the embedded computer 20 via the USB device 28, the Ethernet device 30, the Bluetooth device 34, and the like, and is converted into sewing data by the embedded computer 20.

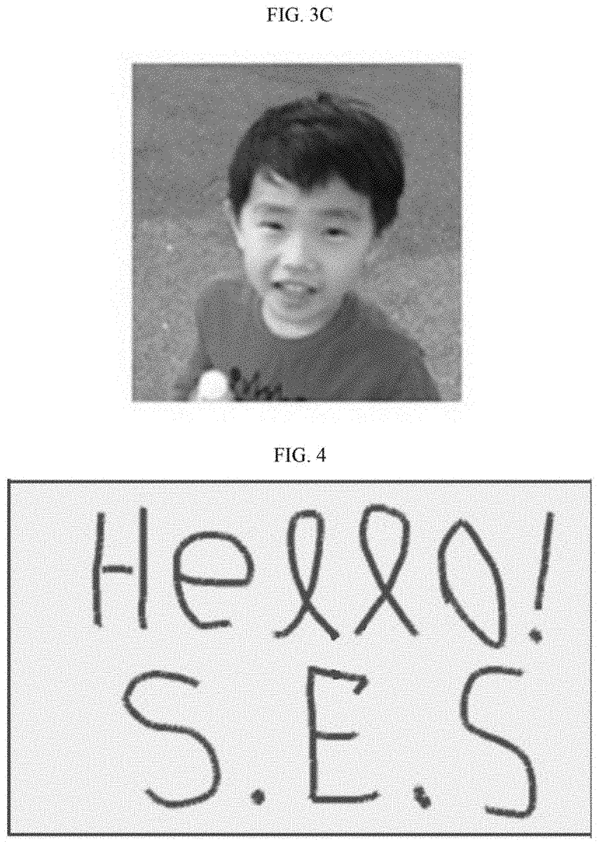

FIG. 4 shows an example of handwriting.

The handwriting are collectively referred to as those obtained by converting a trajectory drawn freely by movement of a hand, a pen, and a mouse pointer into digital data using the touch panel 42, the mouse, or the like.

The handwriting is input to the embedded computer 20 via the touch screen 42, the mouse, etc., and is converted into sewing data by the embedded computer 20.

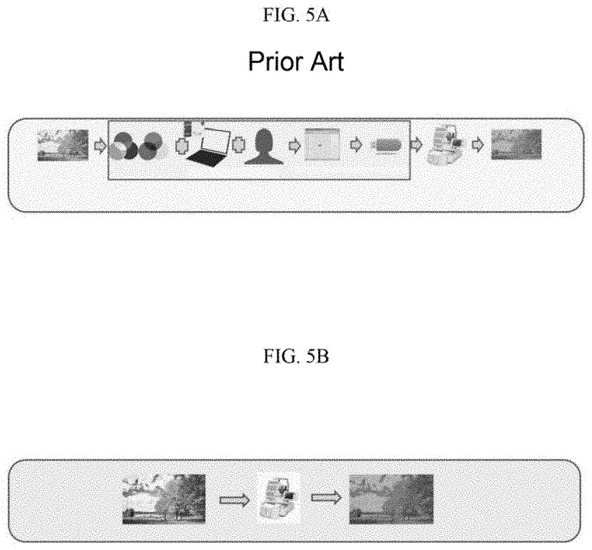

FIGS. 5A and 5B are diagrams for explaining a comparison of the present invention with the related art.

FIG. 5A shows the related art.

Image sizes of image data are adjusted manually, colors are selected using dedicated change software, and a sewing data conversion is manipulated.

Next, the sewing data file is copied to a use file using the USB or the like and the sewing data are stored and set manually to progress the sewing operation and complete the operation.

On the other hand, as shown in FIG. 5B of the present invention, an object of the present invention is to conveniently obtain the sewing data without the manual operation by performing a conversion of a section in a box in FIG. 5A of the related art in the sewing data using the embedded computer.

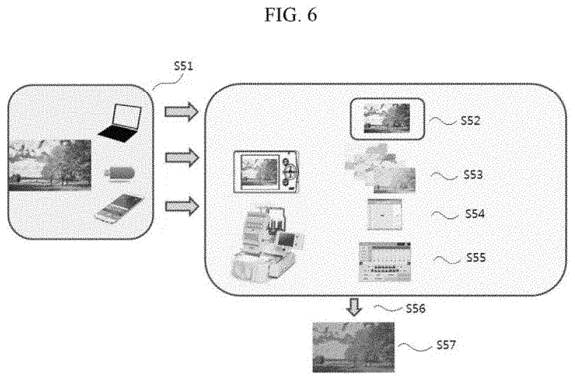

FIG. 6 schematically shows a method for automatically converting image data according to a first embodiment of the method for producing a sewing data file of the present invention.

Referring to FIG. 6, the image data are automatically converted into sewing data using the sewing data conversion program after the process (S51) of inputting image data using the USB device, the Ethernet device, or the Bluetooth device.

In this case, the color of the thread is set, and the frame is set, so the size is automatically adjusted to the operable range of the sewing machine (S52).

Next, the color is automatically extracted and the conversion is performed according to the color of the mounted thread (S53).

That is, the color is automatically classified according to the set color of the thread.

Next, the sewing data conversion program is automatically converted into a sewing data format (S54).

Next, the color change order is automatically set (S55).

Next, the sewing operation can be performed due to the converted data (S56).

Finally, the sewing operation is completed (S57).

The operable range of the sewing machine means the two-dimensional horizontal and vertical sizes in which the X and Y axes driven by the motor of the sewing machine can be physically moved and can be changed according to the type of sewing machines and the type of operation auxiliary fixed frame alternately mounted on the X and Y axes.

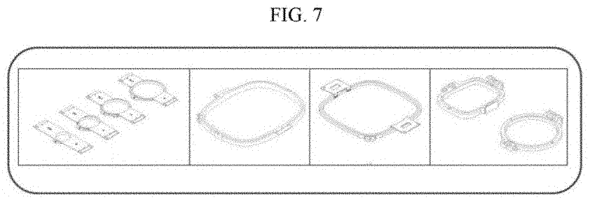

FIG. 7 shows an example of various frames used in the sewing machine.

The frame is a fixture fixed on the X and Y driving device for convenient operation according to the operation type and the work (cloth and leather types) of the sewing, and has shapes such as a square, a circle, and an ellipse and various sizes.

The horizontal and vertical operation range is changed when mounted.

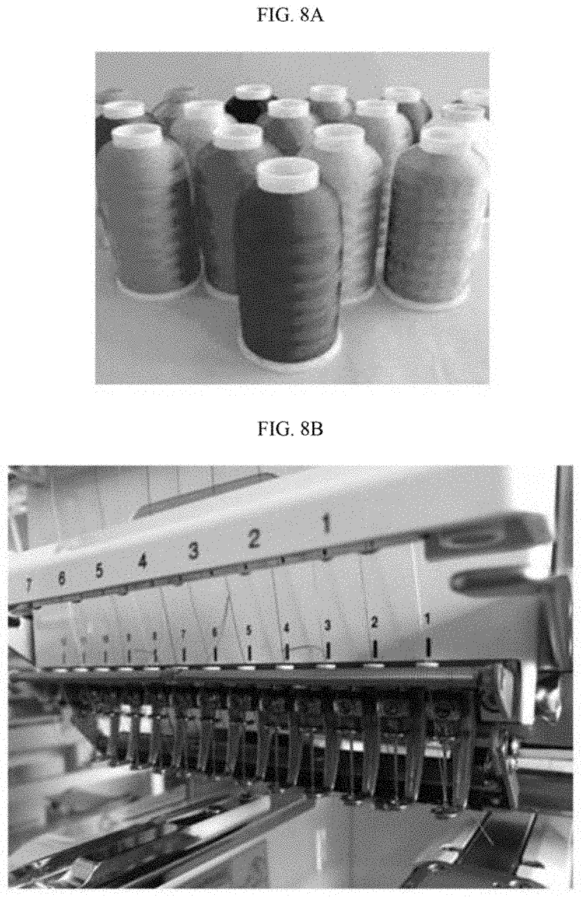

FIG. 8A shows threads of various colors used in the sewing machine.

FIG. 8B is a diagram showing that in the sewing machine, each needle is mounted with threads of different colors corresponding to the number of needles.

By using this, it is possible to obtain results of various colors by a color change among sewing data components.

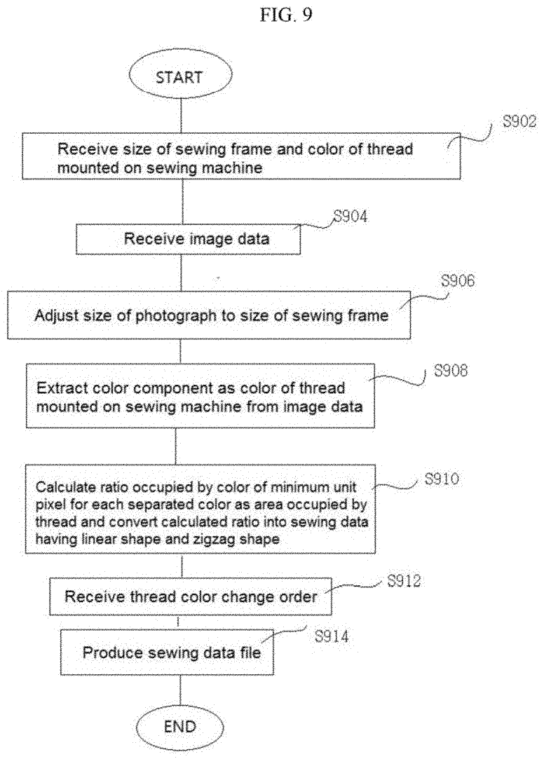

FIG. 9 is a flowchart showing a first embodiment of the method for producing a sewing data file according to the present invention.

First, the size of the frame and the color of the thread mounted on the sewing machine are received from the user (S902).

This operation is performed through the frame setting menu and the thread color information setting menu.

A touch input device, a data input device (keyboard, numerical input key, etc.) can be used to input the size of the frame and the color of the thread.

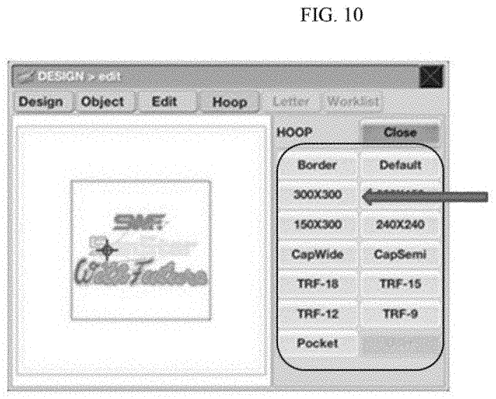

The flow chart of FIG. 9 will be described with reference to FIGS. 10 to 13.

FIG. 10 shows a frame setting menu.

In FIG. 10, the portion shown by the right square box is a place to select a frame to be currently mounted. For example, if a 300×300 frame is mounted on an X and Y driver, 300×300 corresponding to a direction of an arrow in the frame setting menu is selected.

A border refers to the physical horizontal and vertical size. A unit is mm.

300×300 means 300 mm wide by 300 mm high.

TRF-12 means that a round diameter is 120 mm.

If each button is pressed, the corresponding size is selected.

The frame setting menu is not used for every image conversion but is used when the frame is replaced.

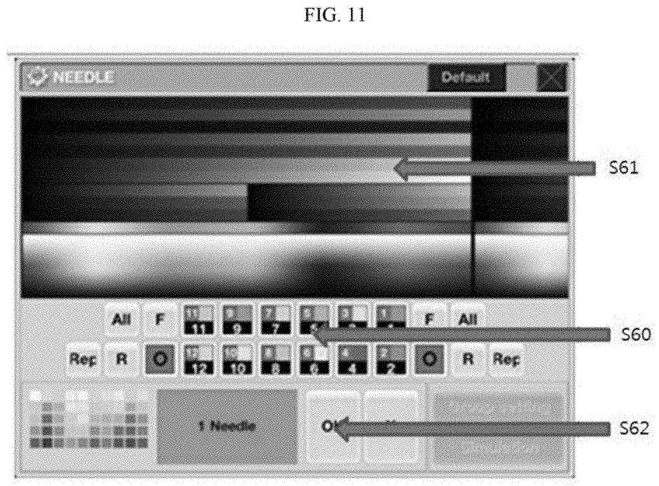

FIG. 11 is a diagram showing a thread color information setting menu.

The thread color information setting menu is used to match the color of a needle bar number with the color of the thread connected to the corresponding needle bar. A needle bar number in the middle of the menu is selected by selecting the needle bar number whose color is to be changed (S60).

Then, the desired color is selected from a color palette on an upper end of the menu (S61).

When an “OK” button is clicked (S62), the selected needle bar number and the selected color information are matched and stored.

The thread color information setting menu is not set for every image conversion, but is used when the thread mounted on the sewing machine is changed.

The image data of FIG. 9 is received (S904).

The image data can be received through a USB memory stick, a memory card (SD, CF, . . . etc.), a network device (LAN, B/T, . . . ) or the like.

The input image data is displayed on the touch screen of the embedded computer 20. At this time, the box indicating the size of the frame is displayed together.

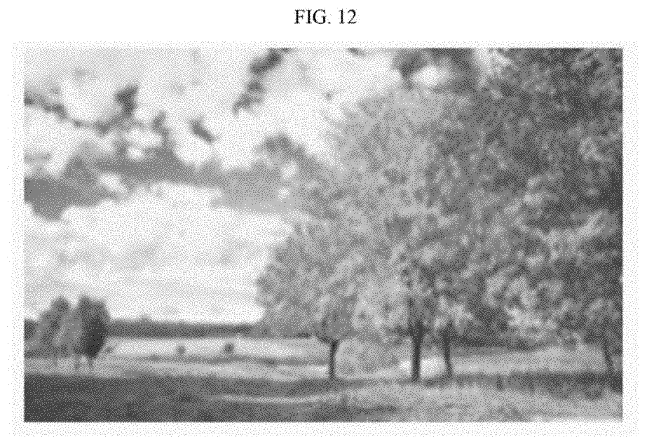

FIG. 12 shows an example of image data displayed on a touch screen.

In FIG. 9, the size of the image data is adjusted to the size of the sewing frame (S906).

If the size of the image data does not match the size of the sewing frame, the size of the image data is adjusted to the size of the sewing frame using the sewing data conversion program. The operation is performed automatically by the sewing data conversion program.

If the size of the image is larger than the size of the set frame, the sewing data conversion program adjusts the size of the image to the size of the set frame.

Next, color components are extracted from the image data of FIG. 9 as the color of the thread mounted on the sewing machine 10 (S908).

The sewing data conversion program extracts the color components from the image data as the color of the thread set through the thread color information setting menu.

Next, a ratio occupied by the color of a minimum unit pixel for each separated color shown in FIG. 9 is calculated as an area occupied by the thread, and is converted into sewing data having a linear shape and a zigzag shape (S910).

Next, the thread color change order is set (S912).

The needle bar change order is set with reference to the separated color information and the color of the thread set through the thread color information setting menu.

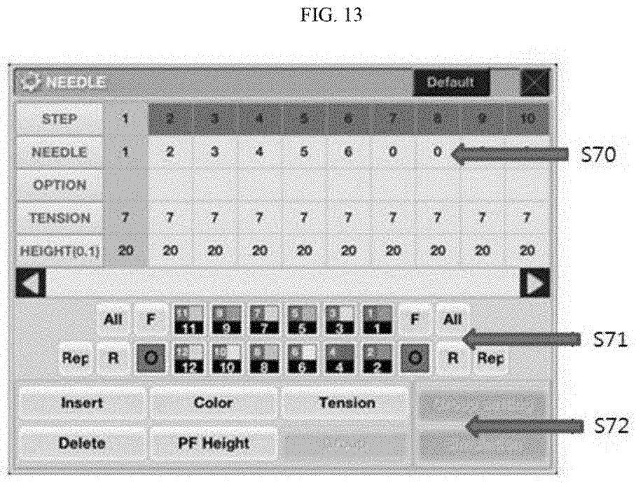

FIG. 13 shows a thread color change order setting menu for arranging the order in which the needles or needle bars assigned with colors are to be used. The change order on a table portion on the upper end of the menu shown in FIG. 13 is clicked (S70).

The needle bar number button in the middle portion is clicked to match the change order with the needle bar number (S71).

If necessary, the order may be changed by using function buttons such as addition and deletion (S72).

The converted data is displayed on the screen, and if necessary, the user adjusts the size, the trajectory, the color of the thread, or the like.

Finally, the sewing data file of FIG. 9 is produced (S914).

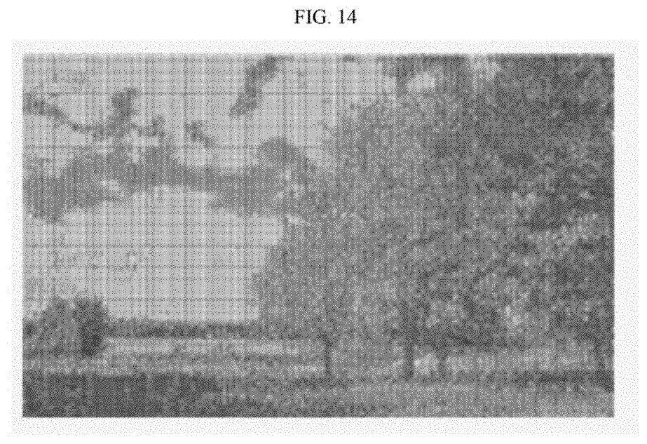

FIG. 14 shows sewing materials produced.

The sewing data file produced is produced according to the size of the frame and the color of the thread which are mounted on the sewing machine, and as a result, as in the conventional sewing data file, it can be understood that the size of the frame and the color of the thread need not to be manually adjusted to be matched with the characteristics of the sewing machine.

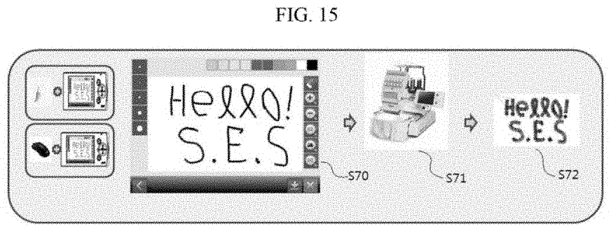

FIG. 15 schematically shows a method for automatically converting handwriting according to a second embodiment of the method for producing a sewing data file of the present invention.

It may be understood that hand painting (including handwriting) input by using the touch screen or the mouse (S70) is converted into the sewing data by the sewing data conversion program (S71).

Accordingly, the operation is completed (S72).

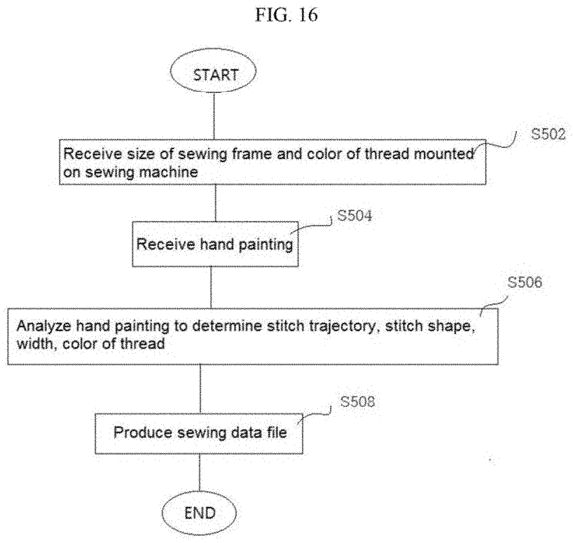

FIG. 16 is a flowchart showing the second embodiment of the method for producing a sewing data file according to the present invention.

First, the size of the frame and the color of the thread mounted on the embroidery machine are received from the user (S502).

This operation is performed through the frame setting menu and the thread color information setting menu.

The touch input device, the data input device (keyboard, numerical input key, etc.) can be used to input the size of the frame and the color of the thread.

Next, the hand painting is received (S504).

At this time, the box indicating the size of the frame is displayed together.

By using the mouse connected to the USB device or using the touch panel, the handwriting is input and tracked by using the input menu displayed in the computer to be converted into data.

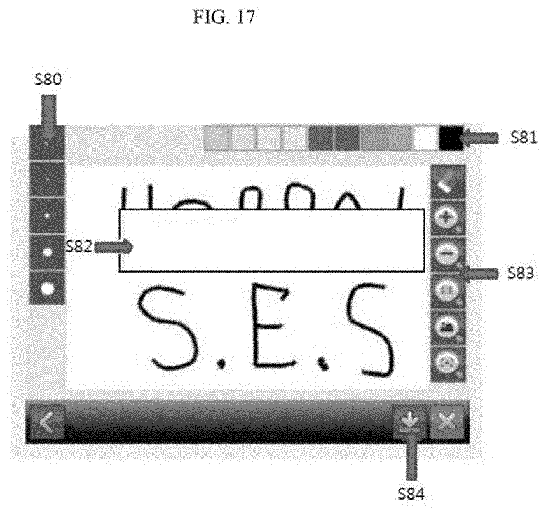

FIG. 17 shows the handwriting input menu.

A thickness of a pen is selected from the hand painting input menu of FIG. 17 (S80). Next, the color is selected (S81). The hand painting is input using a finger or a mouse (S82). If necessary, function buttons such as erasing, enlargement, and contraction are used (S83).

The size of the received window is provided according to the horizontal and vertical sizes stored through the operation range setting menu.

The color selection range is provided with selectable color numbers with reference to the thread color information set through the thread color information setting menu.

A user selects the color to be used, the stitch shape, the thickness, or the like and then uses a hand or a touch pen to freely draw a picture, a text, or the like.

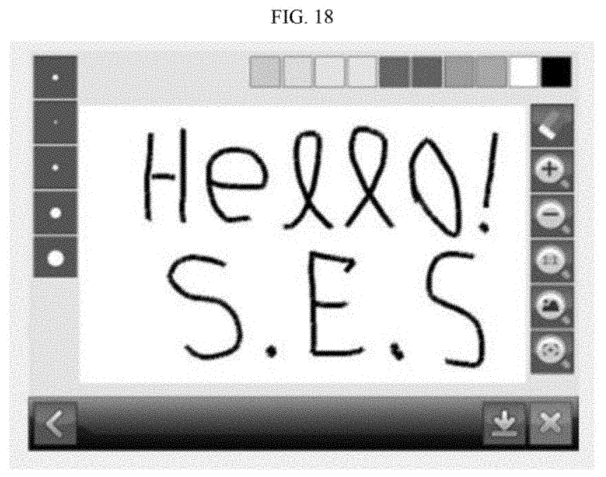

FIG. 18 shows an example of handwriting displayed on the touch screen.

The input hand painting is displayed on the touch screen of the embedded computer.

After the displayed hand painting is completed, a data conversion start button is pressed (S84).

The sewing data conversion program analyzes the handwriting to determine the stitch trajectory, the stitch width, or the like.

The sewing data conversion program tracks an input point to extract the stitch trajectory.

After each stitch shape and colors to which each stitch trajectory is allocated are analyzed by analyzing the hand painting, the sewing data conversion program automatically matches it with the width and the colors of the threads mounted on the sewing machine (S506).

The sewing data conversion program displays the formed stitch on the touch screen according to the stitch trajectory, the stitch shape, the width, and the color of the thread.

The converted data is displayed on the screen, and if necessary, the user adjusts the size, the trajectory, the color of the thread, or the like.

Finally, the sewing data file is produced (S508).

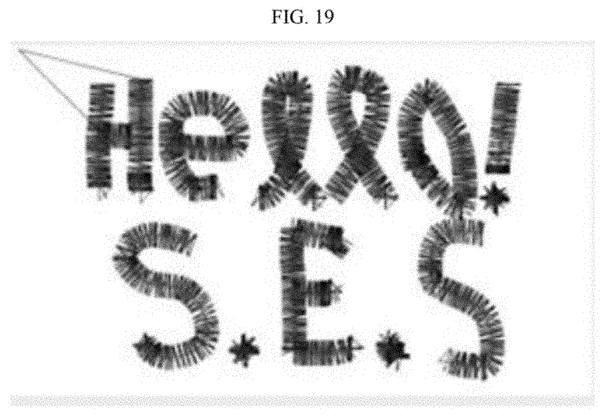

FIG. 19 shows the sewing materials produced.

The sewing data file produced is produced according to the size of the sewing frame and the color of the thread which are mounted on the sewing machine, and as a result, as in the conventional sewing data file, it can be understood that the size of the frame and the color of the thread need not be manually adjusted to be matched with the characteristics of the sewing machine.

Terms and words used in the present specification and claims are not to be construed as a general or dictionary meaning but are to be construed meaning and concepts meeting the technical ideas of the present invention based on a principle that the inventors can appropriately define the concepts of terms in order to describe their own inventions in best mode.

Therefore, the configurations described in the exemplary embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

What is claimed is:

1. A method for producing a sewing data file of a sewing machine including an embedded computer including a sewing data conversion program, a touch input device, a data input device, and a network device, wherein the method produces a sewing data used in the sewing machine by allowing the embedded computer to perform the following processes:
receiving a size of a sewing frame and a color of a thread mounted on the sewing machine through the touch input device and the data input device;
selecting a color to be used, a stitch shape, a thickness and the like through the touch input device and then receiving handwriting;
determining a stitch trajectory, the stitch shape, a width, and a color of a thread by allowing the sewing data conversion program to analyze handwriting: and
producing a sewing data file by using the stitch trajectory, the stitch shape, the width, and the color of the thread determined for every stitch trajectory.

2. The method of claim 1, wherein the embedded computer further performs the following process:
receiving a size of a sewing frame through the touch input device and the data input device; and
adjusting the size of the handwriting to the size of the sewing frame using the sewing data conversion program.

3. The method of claim 2, wherein the embedded computer further perform the following process:
setting a thread color change order, and
the sewing data is produced by referring to a set thread color change order.
